(19) United States
(12) Patent Application Publication
(10) Pub. No.: US 2019/0102354 A1
(43) Pub. Date: Apr. 4, 2019

(54) ALLOCATION OF SHAREABLE ITEM VIA DYNAMIC EXPONENTIATION

(71) Applicant: Hipmunk,Inc., San Francisco, CA (US)

(72) Inventors: Marguerite Ellis, San Francisco, CA (US); Eric Etu, Walnut Creek, CA (US); Adam Julian Goldstein, San Francisco, CA (US)

(21) Appl. No.: 15/724,679

(22) Filed: Oct. 4, 2017

(51) Int. Cl. G06F 17/12; G06F 7/552

(52) U.S. Cl. CPC G06F 17/12; G06Q 10/063; G06F 2207/5523; G06F 7/552

(57) ABSTRACT

An item sharing machine accesses requests to share the same shareable item. Such requests are submitted by requesters and specify numerical values accorded to the shareable item by the requesters. The item sharing machine determines a target extremum share, such as a target maximum share, that will be allocated to the requester that submitted an extremum value, such as the maximum value, for the shareable item. The item sharing machine determines a single common exponent based on each of the submitted values and based on the target extremum share. Having determined the common exponent, the item sharing machine exponentiates each submitted value to the common exponent and allocates shares of the shareable item to the corresponding requesters based on their corresponding exponentiated values.

### TECHNICAL FIELD

The subject matter disclosed herein generally relates to the technical field of special-purpose machines that facilitate allocation of items or portions thereof, such as allocation of portions of graphical user interfaces (GUIs), including software-configured computerized variants of such special-purpose machines and improvements to such variants, and to the technologies by which such special-purpose machines become improved compared to other special-purpose machines that facilitate allocation of items or portions thereof. Specifically, the present disclosure addresses systems and methods to facilitate allocation of a shareable item via dynamic exponentiation.

### BACKGROUND

A machine can be configured to interact with multiple users by receiving requests from users to share a shareable item and then allocating portions (e.g., shares) of the shareable item to at least some of the users who submitted such requests. For example, a server machine may generate a GUI in which a region (e.g., a window, a button, an image, or a zone) of the GUI is available for sharing among multiple requesters (e.g., users who submit requests for linking corresponding machines to the interactive region or obtaining some other benefit therefrom). The server machine may cause the generated GUI to link (e.g., re-link) the region to each requester's machine (e.g., each corresponding server machine) sequentially (e.g., changing every minute or every hour) and provide the generated GUI to one or more client machines (e.g., user devices), thus causing such client machines to present (e.g., display) the GUI with the region linked to different machines at different times.

### BRIEF DESCRIPTION OF THE DRAWINGS

Some embodiments are illustrated by way of example and not limitation in the figures of the accompanying drawings.

FIG. 1 is a network diagram illustrating a network environment suitable for facilitating allocation of a shareable item (e.g., linking an allocable region of a GUI) via dynamic exponentiation, according to some example embodiments.

FIG. 2 is a block diagram illustrating components of an item sharing machine, according to some example embodiments.

FIG. 3 is a conceptual diagram illustrating time-based sharing and allocation of a shareable item, according to some example embodiments.

FIG. 4 is a conceptual diagram illustrating quantity-based sharing and allocation of the shareable item, according to some example embodiments.

FIG. 5 is a conceptual diagram illustrating weighted random sharing and allocation of the shareable item, according to some example embodiments.

FIG. 6-10 are flowcharts illustrating operations of the item sharing machine in performing a method of allocating the shareable item via dynamic exponentiation, according to some example embodiments.

FIG. 11 is a block diagram illustrating components of a machine, according to some example embodiments, able to read instructions from a machine-readable medium and perform any one or more of the methodologies discussed herein.

### SUMMARY

In some implementations, methods and apparatus, including computer program products, are provided for allocation of a shareable item via dynamic exponentiation. That is, the allocation of the shareable item is based on an exponent (e.g., common exponent) that is dynamically determined based on values submitted in requests for the shareable item. The following enumerated embodiments describe various example embodiments of methods, machine-readable media, and systems (e.g., machines, devices, or other apparatus) discussed herein.

A first example embodiment provides a method comprising:

accessing, by one or more processors of a machine, a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining, by one or more processors of the machine, a target extremum percentage of the shareable item;
determining, by one or more processors of the machine, a common exponent based on the target extremum percentage and based on each value in the plurality of values;
exponentiating, by one or more processors of the machine, each value among the plurality of values to the determined common exponent; and
allocating, by one or more processors of the machine, a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

A second example embodiment provides a method according to the first example embodiment, wherein:

the extremum value is a maximum value relative to the plurality of values;
the target extremum percentage of the shareable item is a target maximum percentage of the shareable item; and
the allocating of the plurality of percentages of the shareable item includes allocating the target maximum percentage of the shareable item to a requester among the plurality of requesters, the requester having submitted the maximum value.

A third example embodiment provides a method according to the first example embodiment, wherein:

the extremum value is a minimum value relative to the plurality of values;
the target extremum percentage of the shareable item is a target minimum percentage of the shareable item; and
the allocating of the plurality of proportions of the shareable item includes allocating the target minimum percentage of the shareable item to a requester among the plurality of requesters, the requester having submitted the minimum value.

A fourth example embodiment provides a method according to any of the first through third example embodiments, wherein:

the determining of the target extremum percentage includes accessing a predetermined ultimate percentage; and
the determining of the common exponent determines the common exponent that produces the predetermined ultimate percentage when each value in the plurality of values is exponentiated to the common exponent and the exponentiated extremum value is divided by the summation of each exponentiated value.

A fifth example embodiment provides a method according to the fourth example embodiment, wherein:

the accessing of the predetermined ultimate percentage includes accessing a data structure that indicates the predetermined ultimate percentage is a monopoly definition percentage (e.g., 75%).

A sixth example embodiment provides a method according to any of the first through third example embodiments:

a first requester among the plurality of requesters submitted the extremum value among the plurality of values;
the determining of the target extremum percentage includes calculating a target intermediate percentage partway between a predetermined ultimate percentage and a current percentage that is presently allocated to the first requester that submitted the extremum value; and
the determining of the common exponent determines the common exponent that produces the calculated target intermediate percentage when each value in the plurality of values is exponentiated to the common exponent and the exponentiated extremum value is divided by the summation of each exponentiated value.

A seventh example embodiment provides a method according to the sixth example embodiment, wherein:

the calculated target intermediate percentage is halfway between the predetermined ultimate percentage and the current percentage presently allocated to the first requester that submitted the extremum value.

An eighth example embodiment provides a method according to the sixth embodiment or the seventh example embodiment, further comprising:

accessing the predetermined ultimate percentage by accessing a data structure that indicates the predetermined ultimate percentage is a monopoly definition percentage (e.g., 75%); and wherein:
the calculated target intermediate percentage is partway between the monopoly definition percentage and the current percentage presently allocated to the first requester that submitted the extremum value.

A ninth example embodiment provides a method according to any of the first through eighth example embodiments, wherein:

the determining of the common exponent includes calculating candidate results from a range of candidate exponents, the calculating of the candidate results including, for each candidate exponent in the range:
identifying a different candidate exponent in the range of candidate exponents;
exponentiating each value among the plurality of values inclusive of the extremum value to the identified candidate exponent; and
dividing the exponentiated extremum value by a summation of each exponentiated value.

A tenth example embodiment provides a method according to the ninth example embodiment, wherein:

the range of candidate exponents includes a predetermined plurality of reference candidate exponents of which at least two reference candidate exponents are separated from each other by a predetermined step interval value.

An eleventh example embodiment provides a method according to the ninth example embodiment or the tenth example embodiment, wherein:

the determining of the common exponent includes comparing at least one candidate result among the calculated candidate results to the determined target extremum percentage of the shareable item.

A twelfth example embodiment provides a method according to any of the ninth through eleventh example embodiments, wherein:

the determining of the common exponent includes identifying a candidate exponent whose corresponding candidate result is within a predetermined threshold difference value from the determined target extremum percentage of the shareable item.

A thirteenth example embodiment provides a method according to any of the ninth through twelfth example embodiments, wherein:

the determining of the common exponent includes performing a binary search based on the range of candidate exponents.

A fourteenth example embodiment provides a method according to any of the first through thirteenth example embodiments, wherein:

in the allocating of the plurality of percentages of the shareable item, each requester among the plurality of requesters is allocated a corresponding percentage calculated by dividing the corresponding exponentiated value among the plurality of values by the summation of each exponentiated value among the plurality of values.

A fifteenth example embodiment provides a method according to any of the first through fourteenth example embodiments, wherein:

the shareable item is available for sharing during a time span; and the method further comprises:
allocating portions of the time span to the plurality of requesters based on the plurality of percentages allocated to the plurality of requesters; and
providing exclusive use of the shareable item to each requester among the plurality of requesters based on a corresponding allocated portion of the time span. This may have the effect of implementing time-based sharing of the shareable item.

A sixteenth example embodiment provides a method according to any of the first through fourteenth example embodiments, wherein:

the shareable item is available for sharing during a time span in which the shareable item provides a total quantity of discrete non-shareable items; and the method further comprises:
allocating portions of the total quantity of discrete non-shareable items to the plurality of requesters based on the plurality of percentages allocated to the plurality of requesters; and
providing exclusive use of the shareable item to each requester among the plurality of requesters based on a corresponding allocated portion of the total quantity of discrete non-shareable items. This may have the effect of implementing quantity-based sharing of shareable item.

A seventeenth example embodiment provides a method according to any of the first through fourteenth example embodiments, further comprising:

subdividing a numerical range into sub-ranges that each correspond to a different requester among the plurality of requesters and whose sizes are determined based on the plurality of percentages; and
providing exclusive use of the shareable item to a requester among the plurality of requesters based on a comparison of a randomly generated number to a sub-range that corresponds to the requester. This may have the effect of implementing weighted random sharing of the shareable item.

An eighteenth example embodiment provides a method according to any of the first through seventeenth example embodiment, wherein:

the determining of the common exponent includes calculating the common exponent based on the determined target extremum percentage of the shareable item.

A nineteenth example embodiment provides a machine-readable medium (e.g., a non-transitory machine-readable storage medium) comprising instructions that, when executed by one or more processors of a machine, cause the machine to perform operations comprising:

accessing a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining a target extremum percentage of the shareable item;
determining a common exponent based on the target extremum percentage and based on each value in the plurality of values;
exponentiating each value among the plurality of values to the determined common exponent; and
allocating a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

A twentieth example embodiment provides a system (e.g., a computer system) comprising:

one or more processors; and
a memory storing instructions that, when executed by at least one processor among the one or more processors, cause the system to perform operations comprising:
accessing a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining a target extremum percentage of the shareable item;
determining a common exponent based on the target extremum percentage and based on each value in the plurality of values;
exponentiating each value among the plurality of values to the determined common exponent; and
allocating a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

A twenty-first example embodiment provides a carrier medium carrying machine-readable instructions for controlling a machine to carry out the method of any first through nineteenth example embodiments.

Example methods (e.g., algorithms) discussed herein facilitate allocation of a shareable item via dynamic exponentiation, and example systems discussed herein (e.g., special-purpose machines configured by special-purpose software) are configured to facilitate allocation of a shareable item via dynamic exponentiation. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

### DETAILED DESCRIPTION

In various situations, an item is shareable in the sense that the item itself, use thereof, or a benefit thereof can be shared by multiple requesters One approach is to allocate different portions of the item, its use, or its benefit to different requesters simultaneously or otherwise contemporaneously. For example, a cake can be cut into slices, and each slice can be served to a different diner seated around a dinner table (e.g., at the same time). Another approach is to repeatedly allocate (e.g., re-allocate) the entire item, its entire use, or its entire benefit to different requesters at different times. For example, a sports car can be rented to different renters on different days. However, if one requester obtains an increase in his proportional allocation of the item, its use, or its benefit, then the other requesters typically receive correspondingly decreased proportional allocations of the item, its use, or its benefit. Considering the sports car example, it is possible for one frequent renter to rent the car so often (e.g., 28 days per month) that the other renters' experiences approach being effectively denied the car, and the frequent renter's own experience approaches ownership of the car.

The example methods and systems described herein are discussed in an example context in which the shareable item is an allocable region of a GUI. For example, the allocable region of the GUI may be an available window or other available region (e.g., a button or a particular position within a pulldown menu) of a webpage or other web interface, where allocation of the region includes linking the region to a particular requester's machine (e.g., such that the requester's machine will receive the next clickthrough when a user clicks on the allocable region), or where allocation of the region includes retrieval and incorporation of some content from the particular requester's machine (e.g., causing the requester's machine to receive a page view request when the region is next rendered to a user's browser). The example methods and systems described herein are also adaptable to other contexts, and the shareable item can be any item (e.g., a good, a service, or a license or other authorization) that an item sharing machine may provide, deliver, cause to be delivered, assign, or otherwise allocate to different requesters at different times.

A machine (e.g., a server computer or other server machine) is configured by appropriate software (e.g., software modules) to function as an item sharing machine (e.g., a GUI linking machine), and the item sharing machine is accordingly configured to receive or otherwise access requests to share the same shareable item (e.g., allocation requests in the form of bids on an allocable region of a GUI). Such requests (e.g. share requests) are submitted by requesters (e.g., users acting as bidders for the allocable region). The requests also specify various numerical values (e.g., bid values) that are submitted by the requesters and accorded to the shareable item by the requesters for obtaining a share of the shareable item. The item sharing machine then determines a target extremum share (e.g., a target maximum share or a target minimum share) that will be given to the requester that submitted an extremum value (e.g., maximum value or minimum value among the submitted values) for the shareable item. The target extremum share may be expressed as a percentage of the shareable item (e.g., 70%, 75%, or 80%).

The item sharing machine is configured to allocate shares of the shareable item to the requesters based on (e.g., with at least some influence from) exponentiated values corresponding to the requesters (e.g., exponentiated versions of the values submitted by the requesters). The degree to which the requesters' submitted values are exponentiated is determined dynamically by the item sharing machine, for example, based on the values submitted by the requesters. In particular, the item sharing machine determines a single common exponent that, when each of the submitted values is raised to the common exponent (e.g., with subsequent normalization to obtain percentages of the shareable item), provides the target extremum share of the shareable item to the requester who submitted the extremum value in his or her corresponding request for the shareable item. Having determined the common exponent that satisfies this condition, the item sharing machine exponentiates each submitted value to the common exponent (e.g., with subsequent normalization) and allocates shares (e.g., percentages) of the shareable item to the corresponding requesters based on their corresponding exponentiated values.

In an example context where the item sharing machine is a GUI linking machine, the GUI linking machine may repeatedly update an allocable region of a GUI by repeatedly and selectively linking (e.g., re-linking) the allocable region to different machines (e.g., different server machines) of different requesters, based on the exponentiated values submitted by the requesters. In some cases, the GUI linking machine implements a weighted random sharing algorithm in which the GUI linking machine subdivides a numerical range into sub-ranges that each corresponds to a different requester and is sized based on the corresponding exponentiated value for that requester. Each time the GUI linking machine generates or updates the GUI, the GUI linking machine generates a random number and compares the random number to the sub-ranges. As used herein, the phrase “random number” includes truly random numbers as well as pseudorandom numbers. The GUI linking machine links the allocable region to the machine of the requester whose corresponding sub-range includes the random number. The allocable region of the GUI accordingly becomes linked to different machines (e.g., servers) of different requesters at different times, and the GUI linking machine is thus configured to cause one or more user devices (e.g., client devices) to present the GUI with the allocable region linked to such machines at different times.

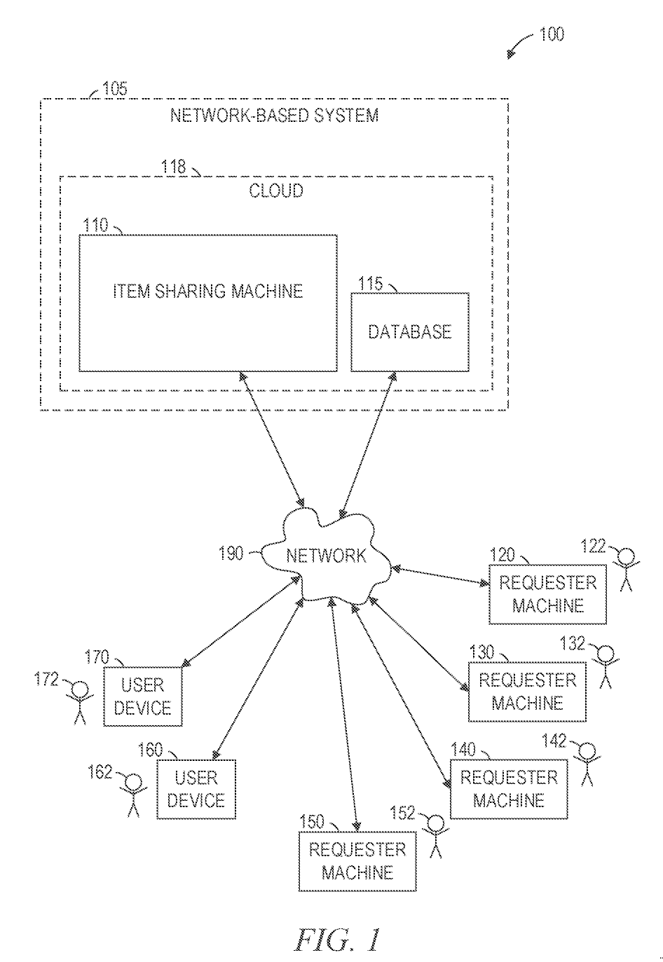

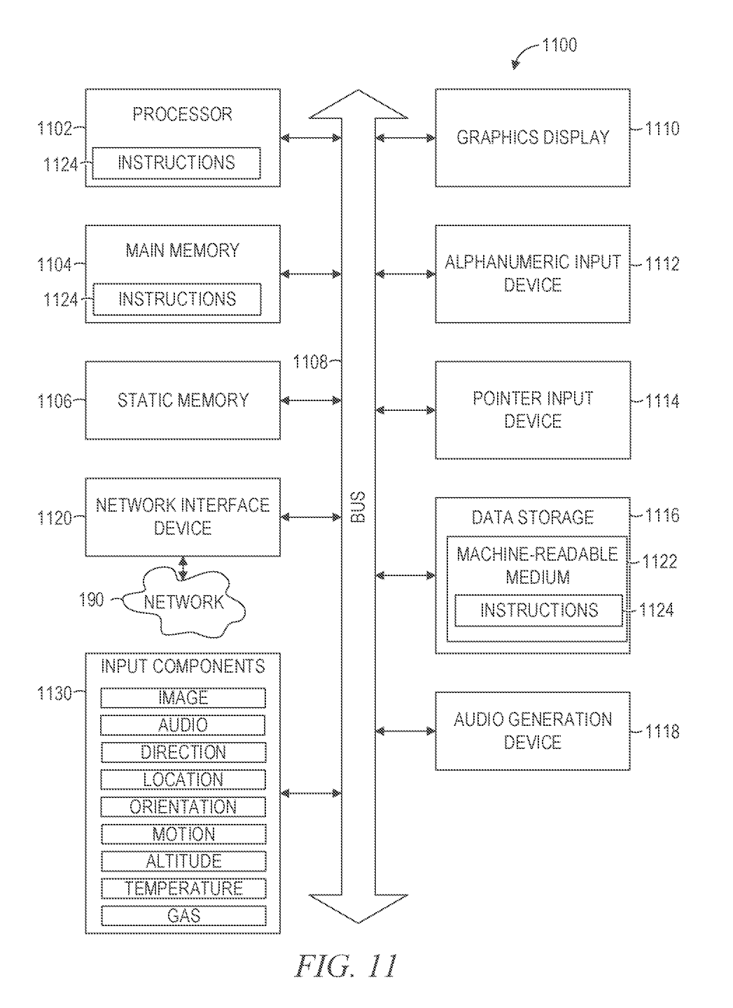

FIG. 1 is a network diagram illustrating a network environment 100 suitable for facilitating allocation of a shareable item (e.g., linking an allocable region of a GUI) via dynamic exponentiation, according to some example embodiments. The network environment 100 includes an item sharing machine 110, a database 115, some requester machines 120, 130, 140, and 150, and some user devices 160 and 170, all communicatively coupled to each other via a network 190. The item sharing machine 110, with or without the database 115 may form all or part of a cloud 118 (e.g., a geographically distributed set of multiple machines configured to function as a single server), which may form all or part of a network-based system 105 (e.g., a cloud-based server system configured to provide one or more network-based services to the requester machines 120, 130, 140, and 150, the user devices 160 and 170, or any suitable combination thereof). The item sharing machine 110, any one or more of the requester machines 120, 130, 140, and 150, and one or both of the user devices 160 and 170 may each be implemented in a special-purpose (e.g., specialized) computer system, in whole or in part, as described below with respect to FIG. 11.

Also shown in FIG. 1 are requesters 122, 132, 142, and 152 for a shareable item, as well as users 162 and 172 of the network-based system 105. Any one or more of the requesters 122, 132, 142, and 152 may be a human user (e.g., a human being), a machine user (e.g., a computer configured by a software program to interact with a corresponding requester machine), or any suitable combination thereof (e.g., a human assisted by a machine or a machine supervised by a human). The requester 122 is associated with the requester machine 120 and may be a user, owner, or other decision-making entity of the requester machine 120. The requester 132 is associated with the requester machine 130 and may be a user, owner, or other decision-making entity of the requester machine 130. The requester 142 is associated with the requester machine 140 and may be a user, owner, or other decision-making entity of the requester machine 140. The requester 152 is associated with the requester machine 150 and may be a user, owner, or other decision-making entity of the requester machine 150. Any one or more of the requester machines 120, 130, 140, and 150 may be or include a desktop computer, a vehicle computer, a tablet computer, a navigational device, a portable media device, a smart phone, or a wearable device (e.g., a smart watch, smart glasses, smart clothing, or smart jewelry) belonging to the corresponding requester (e.g., requester 122, 132, 142, or 152).

One or both of the users 162 and 172 may be a human user (e.g., a human being), a machine user (e.g., a computer configured by a software program to interact with the device 160 or 170), or any suitable combination thereof (e.g., a human assisted by a machine or a machine supervised by a human). The user 162 is associated with the device 160 and may be a user of the device 160. For example, the device 160) may be or include a desktop computer, a vehicle computer, a tablet computer, a navigational device, a portable media device, a smart phone, or a wearable device (e.g., a smart watch, smart glasses, smart clothing, or smart jewelry) belonging to the user 162. Likewise, the user 172 is associated with the device 170 and may be a user of the device 170. As an example, the device 170 may be or include a desktop computer, a vehicle computer, a tablet computer, a navigational device, a portable media device, a smart phone, or a wearable device (e.g., a smart watch, smart glasses, smart clothing, or smart jewelry) belonging to the user 172.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 11, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the item sharing machine 110 and the requester machine 120, or between the item sharing machine 110 and the user device 160). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

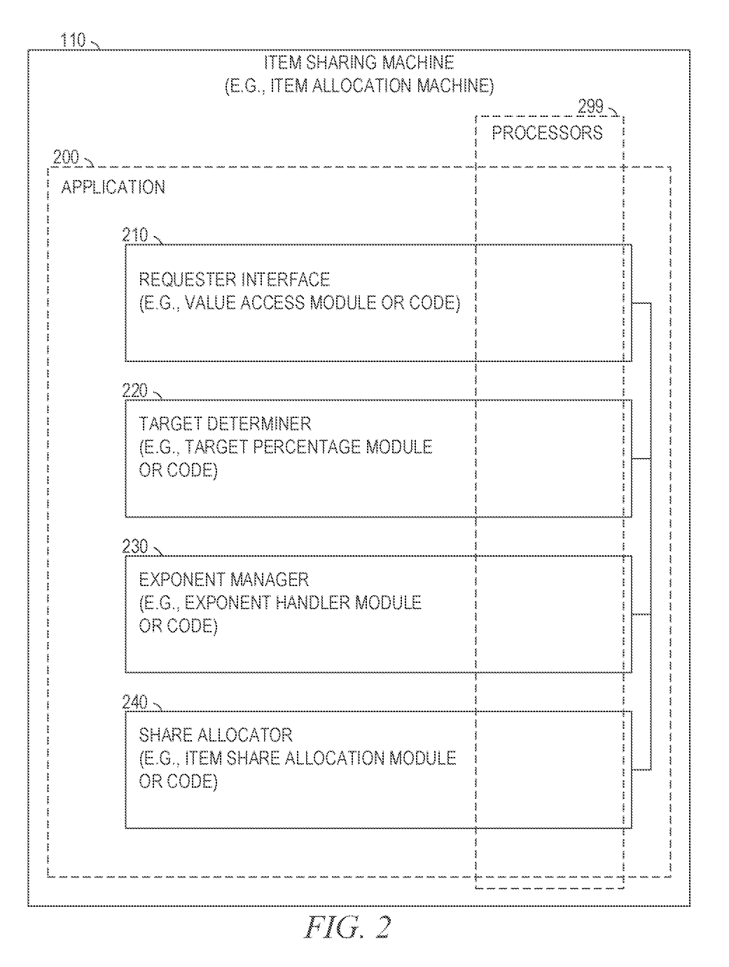

FIG. 2 is a block diagram illustrating components of the item sharing machine 110, according to some example embodiments. The item sharing machine 110 is shown as including a requester interface 210, a target determiner 220, an exponent manager 230, and a share allocator 240, all configured to communicate with each other (e.g., via a bus, shared memory, or a switch). The requester interface 210 may be or include a value access module or similarly suitable code (e.g., configured to access one or more values submitted by one or more of the requesters 122, 132, 142, and 152). The target determiner 220 may be or include a target percentage module or similarly suitable code (e.g., configured to determine a target share of a shareable item, for example, as a percentage of the shareable item). The exponent manager 230 may be or include an exponent handler module or similarly suitable code (e.g., configured to determine a common exponent to be applied to the values submitted by one or more of the requesters 122, 132, 142, and 152). The share allocator 240 may be or include an item share allocation module or similarly suitable code (e.g., configured to allocate shares of a shareable item to corresponding requesters, for example, by linking the shareable item to corresponding requester machines).

As shown in FIG. 2, the requester interface 210, the target determiner 220, the exponent manager 230, the share allocator 240, or any suitable combination thereof, may form all or part of an application 200 (e.g., a server-side application, a client-side application, a mobile app, or any suitable combination thereof) that is stored (e.g., installed) on the machine 110 (e.g., responsive to or otherwise as a result of data being received from the item sharing machine 110 via the network 190). Furthermore, one or more processors 299 (e.g., hardware processors, digital processors, or any suitable combination thereof) may be included (e.g., temporarily or permanently) in the application 200, the requester interface module 210, the target determiner module 220, exponent manager 230, share allocator 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

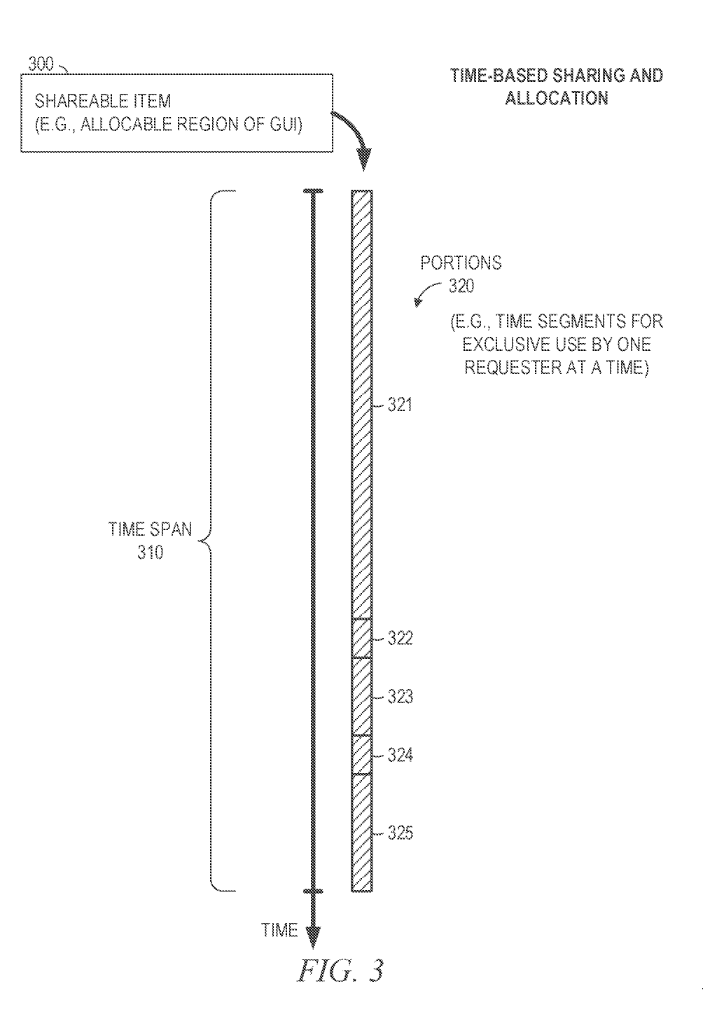

FIG. 3 is a conceptual diagram illustrating time-based sharing and allocation of a shareable item 300 (e.g. an allocable region of a GUI), according to some example embodiments. As noted above, the shareable item 300 can be any item (e.g., a good, a service, or a license or other authorization) that the item sharing machine 110 may provide, deliver, cause to be delivered, assign, or otherwise allocate to different requesters (e.g., requesters 122, 132, 142, and 152) at different occasions. As shown in FIG. 3, the shareable item 300 is available during a time span 310 (e.g., one day, one week, one month, or one year), and various portions 320 of the time span 310 can be allocated to corresponding requesters (e.g., requesters 122, 132, 142, and 152, as well as a further requester). Thus, the portion 321 of the time span 310 may be a first time segment in which the shareable item 300 is exclusively allocated to the requester 122; the portion 322 of the time span 310 may be a second time segment in which the shareable item 300 is exclusively allocated to the requester 132; the portion 323 of the time span 310 may be a third time segment in which the shareable item 300 is exclusively allocated to the requester 142, the portion 324 of the time span 310 may be a fourth time segment in which the shareable item 300 is exclusively allocated to the requester 152; and the portion 325 of the time span 310 may be a fifth time segment in which the shareable item 300 is exclusively allocated to a further requester.

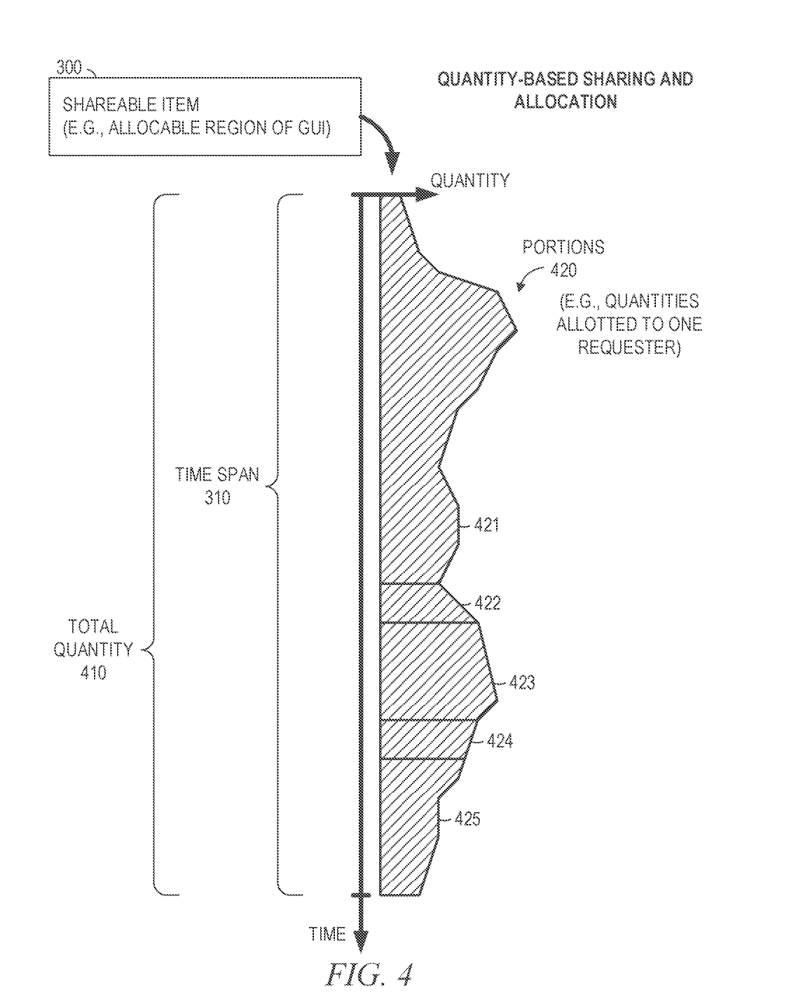

FIG. 4 is a conceptual diagram illustrating quantity-based sharing and allocation of the shareable item 300, according to some example embodiments. As shown in FIG. 4, the shareable item 300 is available during the time span 310, in which a total quantity 410 of countable benefits (e.g., clicks on the allocable region of the GUI or other discrete non-shareable benefits, such as discrete non-shareable items) is available from the shareable item 300. Various portions 420 of the total quantity 410) can be allocated to corresponding requesters (e.g., requesters 122, 132, 142, and 152, as well as a further requester). Accordingly, the portion 421 of the total quantity 410 may be a first quantity of benefits (e.g., clicks) exclusively allocated to the requester 122; the portion 422 of the total quantity 410 may be a second quantity of benefits exclusively allocated to the requester 132, the portion 423 of the total quantity 410 may be a third quantity of benefits exclusively allocated to the requester 142; the portion 424 of the total quantity 410 may be a fourth quantity of benefits exclusively allocated to the requester 152; and the portion 425 of the total quantity 410 may be a fifth quantity of benefits exclusively allocated to a further requester.

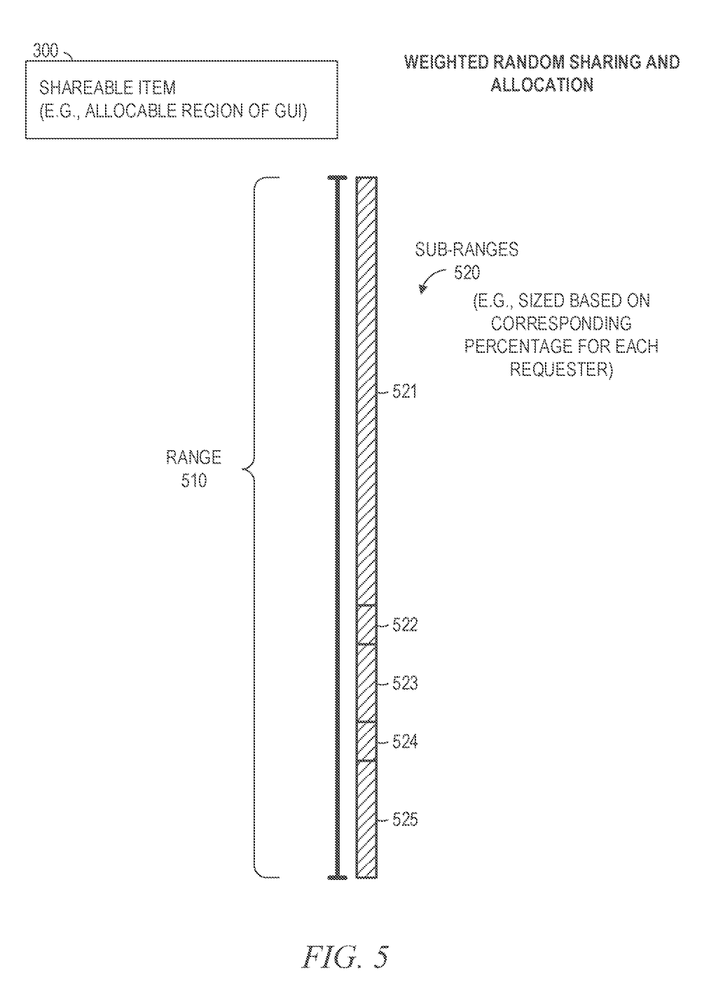

FIG. 5 is a conceptual diagram illustrating weighted random sharing and allocation of the shareable item 300, according to some example embodiments. As shown in FIG. 5, a numerical range 510 (e.g., 0 . . . 1) can be subdivided into sub-ranges 520, and each of the sub-ranges 520 may correspond to a different requester (e.g., requesters 122, 132, 142, or 152, or a further requester). Furthermore, each of the sub-ranges may be sized based on the corresponding exponentiated value for its corresponding requester. For example, supposing that the item sharing machine 110 has previously determined that a common exponent of 4 will be applied to each value submitted by the requesters (e.g., requesters 122, 132, 142, and 152, plus a further requester) for the shareable item 300, the item sharing machine 110 may raise each of the values submitted by the requesters to the common exponent of 4 and determine the sizes of the sub ranges 520 based on the results of raising the values to the common exponent of 4 (e.g., after normalizing the results to obtain a corresponding percentages).

Accordingly, the sub-range 521 may correspond to the requester 122 and have a first size that is determined (e.g., calculated) based on the value submitted by the requester 122, raised to the common exponent (e.g., raised to the fourth power); the sub-range 522 may correspond to the requester 132 and have a second size that is determined based on the value submitted by the requester 132, raised to the common exponent; the sub-range 523 may correspond to the requester 142 and have a third size that is determined based on the value submitted by the requester 142, raised to the common exponent, the sub-range 524 may correspond to the requester 152 and have a fourth size that is determined based on the value submitted by the requester 152, raised to the common exponent; and the sub-range 525 may correspond to a further requester and have a fifth size that is determined based on the value submitted by the further requester, raised to the common exponent. For example, these exponentiated values may be normalized (e.g., within the range of 0.1) and treated by the item sharing machine 110 as percentages for allocating the shareable item 300 to the requesters (e.g., requesters 122, 132, 142, and 152, plus the further requester).

Hence, in accordance with FIG. 5, the item sharing machine 110 can allocate the shareable item 300 to different requesters at different times, by generating a random number each time that a benefit (e.g., a click or view corresponding to the allocable region of the GUI) from the shareable item 300 is to be distributed and then comparing the random number to the sub-ranges 520. The item sharing machine 110 can then allocate the shareable item (e.g., provide the benefit) to the requester (e.g., requester 122) whose corresponding sub-range (e.g., sub range 521) includes the random number.

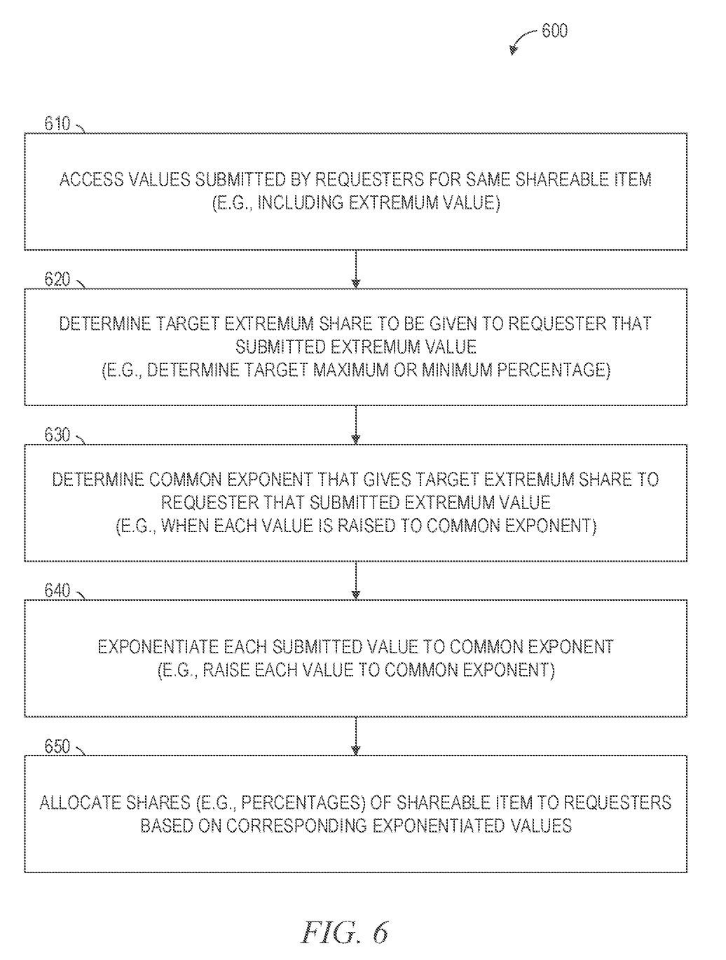

FIG. 6-10 are flowcharts illustrating operations of the item sharing machine 110 in performing a method 600 of allocating the shareable item 300 via dynamic exponentiation, according to some example embodiments Operations in the method 600 may be performed by the item sharing machine 110, using components (e.g., modules) described above with respect to FIG. 2, using one or more processors (e.g., microprocessors or other hardware processors), or using any suitable combination thereof. As shown in FIG. 6, the method 600 includes operations 610, 620, 630, 640, and 650.

In operation 610, the requester interface 210 accesses values that have been collectively submitted by requesters (e.g., requesters 122, 132, 142, and 152) for the shareable item 300. The accessing of such values may be performed by receiving or otherwise accessing requester-submitted requests (e.g., share requests) directly from one or more requester machines (e.g., requester machines 120, 130, 140, and 150) via the network 190, accessing such requests received or stored elsewhere (e.g., by the database 115), or any suitable combination thereof. As noted above, each of these values has been assigned to the shareable item 300 by a different corresponding requester (e.g., requester 122) among the requesters. Moreover, the accessed values include an extremum value relative to the other accessed values. The extremum value may be a maximum value or a minimum value, in various example embodiments.

In operation 620, the target determiner 220 determines a target extremum share (e.g., expressed as a target extremum percentage) of the shareable item 300. The target extremum share represents the proportional amount of the shareable item 300 (e.g., itself, its use, or its benefit) that will be allocated to the requester (e.g., requester 122) that submitted the extremum value (e.g., maximum value) accessed in operation 610. The determined target extremum share may be expressed as a target maximum percentage or a target minimum percentage, in various example embodiments.

In operation 630, the exponent manager 230 determines a common exponent that produces or otherwise results in the target extremum share (e.g., target extremum percentage) when each of the values accessed in operation 610 is exponentiated (e.g., raised) to the common exponent and then the exponentiated extremum value (e.g., maximum value) is divided by a summation of each exponentiated value (e.g., a summation of all accessed values after each has been raised to the common exponent) to obtain the target extremum share. In some example embodiments, the determining of the common exponent includes calculating the common exponent in accordance with an algebraic formula that takes the determined target extremum share and the accessed values as input. For example, such an algebraic formula may include a quotient that results from dividing the target extremum percentage by unity (i.e., 1) decreased by (e.g., less) the target extremum percentage.

In operation 640, the exponent manager 230 performs the exponentiation of each of the values accessed in operation 610 to the common exponent determined in operation 630. That is, the exponent manager 230 exponentiates (e.g., raises) each of the values to the common exponent. According to some example embodiments, the exponent manager 230 performs additional processing by calculating the summation of each exponentiated value (e.g., the summation of all exponentiated values). According to certain example embodiments, the exponent manager 230 performs further processing by normalizing the exponentiated values (e.g., to corresponding percentages). This normalization may include calculating corresponding quotients for the requesters (e.g., requesters 122, 132, 142, and 152). The calculation of such quotients may be performed by dividing the exponentiated value from each requester by the summation of each exponentiated value.

In operation 650, the share allocator 240 allocates shares of the shareable item 300 to the requesters (e.g., requesters 122, 132, 142, and 152). This may be performed by allocating corresponding percentages of the shareable item 300 to the requesters based on the exponentiated values discussed above with respect to operation 640. Accordingly, each requester (e.g., requester 122) among the requesters is allocated a corresponding share (e.g., percentage) of the shareable item 300, and his or her corresponding share is allocated based on the corresponding exponentiated value calculated in operation 640.

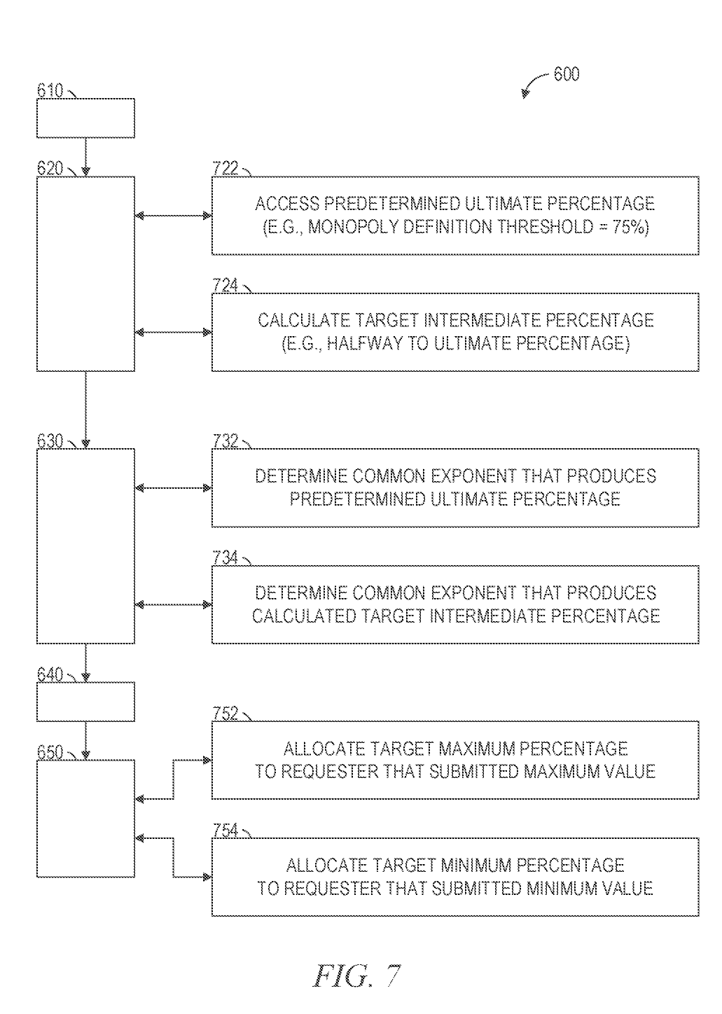

As shown in FIG. 7, in addition to any one or more of the operations previously described, the method 600 may include one or more of operations 722, 724, 732, 734, 752, and 754. In some example embodiments, the item sharing machine 110 is configured to directly determine and allocate a predetermined ultimate share (e.g., predetermined ultimate percentage) of the shareable item 300 to the requester (e.g., requester 122) that submitted the extremum value. Accordingly, in such example embodiments, operation 722 is performed as part (e.g., a precursor task, a subroutine, or a portion) of operation 620, in which the target determiner 220 determines the target extremum share. In these example embodiments, corresponding operation 732 is performed as part of operation 630, in which the exponent manager 230 determines the common exponent being given to the requester that submitted the extremum value.

Specifically, in operation 722, the target determiner 220 determines the target extremum percentage by accessing the predetermined ultimate share (e.g. a final target percentage, which may be a final target maximum percentage or a final target minimum percentage) for the shareable item 300. This predetermined ultimate share may be accessed from a data structure (e.g., stored in the database 115 or hardcoded into the application 200), and such a data structure may indicate that the predetermined ultimate share is a monopoly definition percentage (e.g., a threshold percentage indicating that any higher percentage would effectively constitute a monopoly). Accordingly, in corresponding operation 732, the exponent manager 230 determines the common exponent that produces or otherwise results in the accessed ultimate share when each of the values (e.g., accessed in operation 610) is exponentiated to the common exponent and the exponentiated extremum value is divided by the summation of the exponentiated values.

However, in alternative example embodiments, the item sharing machine 110 is configured to determine and allocate a target intermediate share (e.g., target intermediate percentage) of the shareable item 300 to the requester (e.g., requester 122) that submitted the extremum value, where the target intermediate share is partway (e.g., halfway) towards the predetermined ultimate share of the shareable item 300. Accordingly, in such example embodiments, operation 722 is performed as described above, to access the predetermined ultimate share, and then operation 724 is also performed as part of operation 620. In these example embodiments, corresponding operation 734 is performed as part of operation 630.

Specifically, in operation 724, the target determiner 220 calculates the target intermediate share (e.g., target intermediate percentage) that lies partway (e.g., halfway) between the accessed ultimate share and a current share (e.g., current percentage) that is presently allocated to the requester (e.g., requester 122, which may be deemed a first requester) that submitted the extremum value. This target intermediate share may be calculated as a midpoint between the accessed ultimate share and the current share. Accordingly, in corresponding operation 734, the exponent manager 230 determines the common exponent that produces or otherwise results in the calculated target intermediate share when each of the values (e.g., accessed in operation 610) is exponentiated to the common exponent and the exponentiated extremum value is divided by the summation of the exponentiated values.

As also shown in FIG. 7, either operation 752 or operation 754 may be performed as part of operation 650, in which the share locator 240 allocates the shares of the shareable item 300. In example embodiments where the extremum value is a maximum value, and the target extremum share of the shareable item 300 is a target maximum percentage of the shareable item 300, the share allocator 240 performs operation 752 as part of operation 650 and accordingly allocates the target maximum percentage (e.g., 75%) of the shareable item 300 to the requester (e.g., requester 122) that submitted the maximum value for the shareable item 300.

In example embodiments where the extremum value is a minimum value, and the target extremum share of the shareable item 300 is a target minimum percentage of the shareable item 300, the share allocator 240 performs operation 754 as part of operation 650 and accordingly allocates the target minimum percentage (e.g., 15%) of the shareable item 300 to the requester (e.g., requester 152) that submitted the minimum value for the shareable item 300.

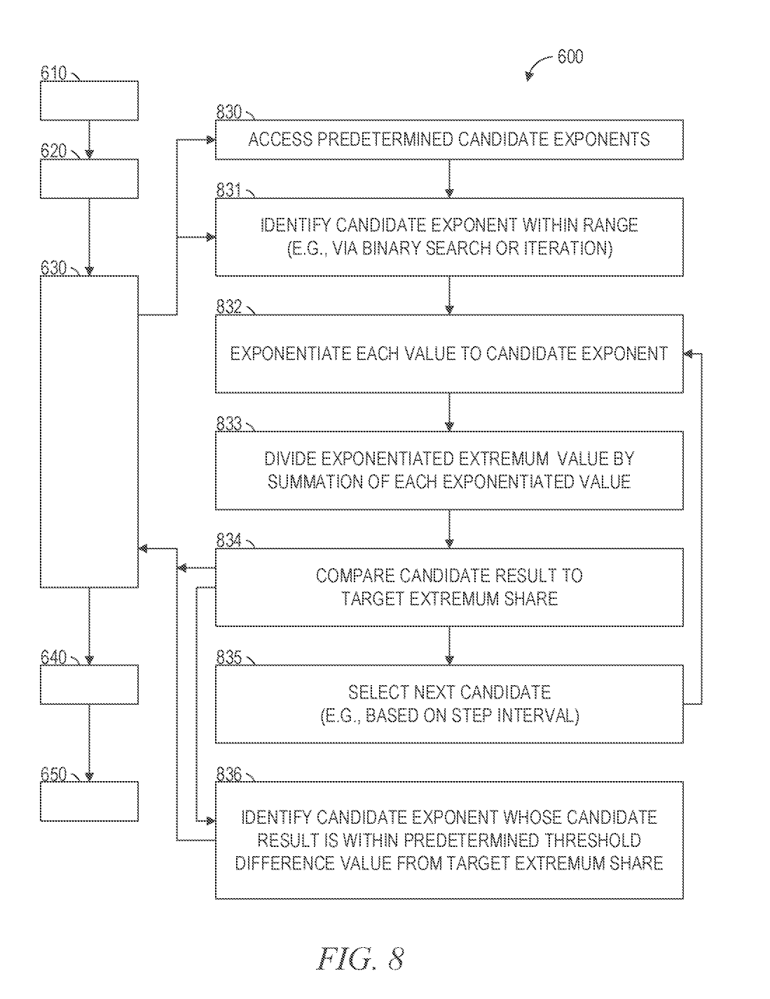

As shown in FIG. 8, in addition to any one or more of the operations previously described, the method 600 may include one or more of operations 830, 831, 832, 833, 834, 835, and 836, any one or more of which may be performed as part of operation 630, in which the exponent manager 230 determines the common exponent. In operation 830, the exponent manager 230 accesses a predetermined set of candidate exponents (e.g., a predetermined reference range of potential values for the common exponent that is being determined in operation 630). The predetermined set of candidate exponents may be accessed from a data structure (e.g., stored by the database 115 or hardcoded into the application 200).

In operation 831, the exponent manager 230 identifies a candidate exponent within the accessed set of candidate exponents (e.g., the accessed range of candidate exponents). The identification of the candidate exponent may be performed as part of an iterative analysis of all or part of the accessed set of candidate exponents. For example, operation 831 may be performed as part of a binary search whose convergence determines the common exponent that fulfills the condition discussed above with respect to operation 630. As another example, operation 831 may be performed as part of a sequential test of a series of candidate exponents within the accessed set of candidate exponents to find the common exponent that fulfills the condition discussed above with respect operation 630.

In operation 832, the exponent manager 230 exponentiates each of the values accessed in operation 610 to the candidate exponent identified in operation 831. That is, the exponent manager 230 exponentiates (e.g., raises) each of the values to the identified candidate exponent. According to some example embodiments, the exponent manager 230) performs additional processing here by calculating the summation of each exponentiated value (e.g., the summation of all exponentiated values).

In operation 833, the exponent manager 230 normalizes the exponentiated values (e.g., to corresponding percentages) from operation 832. This normalization may include calculating corresponding quotients for the requesters (e.g., requesters 122, 132, 142, and 152). The calculation of such quotients may be performed by dividing the exponentiated value from each requester by the summation of each exponentiated value.

In operation 834, the exponent manager 230 compares the result of operation 833, which may be deemed as a candidate result, with the target extremum share determined in operation 620. Based on this comparison, the exponent manager 230 may continue processing the set of candidate exponents accessed in operation 831, or the exponent manager 230 may determine that the current (e.g., latest) candidate exponent satisfies the condition discussed above with respect operation 630, either exactly or sufficiently close (e.g., has discussed below with respect to operation 836).

In operation 835, when continuing to perform an iterative analysis of all or part of the set of candidate exponents accessed in operation 830, the exponent manager 230 selects the next candidate exponent from the set of candidate exponents, and such selection may be based on a step interval value (e.g., predetermined step interval value) that separates at least two candidate exponents from each other. For example, the set of candidate exponents may include a monotonic series of reference exponents (e.g., 4.0, 4.2, 4.4, 4.8, 5.0, 5.2, and 5.4) that are each separated from each other by an integer multiple of a predetermined reference step interval (e.g., 0.2), and the exponent manager 230 may select the next candidate exponent in the monotonic series by incrementing or decrementing the current candidate exponent by the reference step interval.

In operation 836, the exponent manager 230 identifies the current candidate exponent based on the fact that its corresponding candidate result (e.g., as compared to the target extremum share in operation 834) is within a predetermined threshold difference value from the target extremum share. The predetermined threshold difference value may be accessed from a data structure (e.g., stored by the database 115 or hardcoded in the application 200).

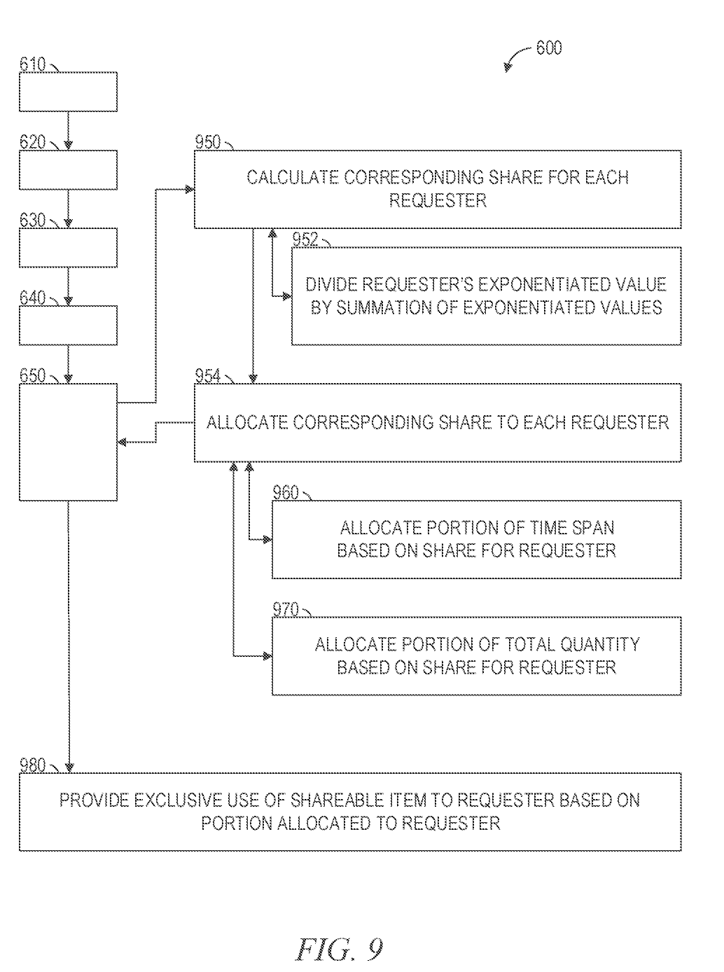

As shown in FIG. 9, in addition to any one or more of the operations previously described, the method 600 may include one or more of operations 950, 952, 954, 960, 970, and 980. In example embodiments where similar operations have not yet already been performed by the exponent manager 230 as part of operation 640, one or more of operations 950, 952, and 954 may be performed as part of operation 650, in which the share allocator 240 allocates the shares of the shareable item 300 to the requesters (e.g., requesters 122, 132, 142, and 152), based on their corresponding exponentiated values obtained in operation 640.

In operation 950, the share allocator 240 calculates the corresponding share (e.g., percentage) of the shareable item 300 for each of the requesters (e.g., requester 122, 132, 142, and 152). This may include calculating the summation of each exponentiated value (e.g., the summation of all exponentiated values) resulting from operation 640.

As shown in FIG. 9, operation 952 may be performed as part of operation 950. In operation 952, the share allocator 240 normalizes the exponentiated values from operation 640 (e.g., to obtain corresponding percentages). This normalization may include calculating corresponding quotients for the requesters (e.g., requesters 122, 132, 142, and 152). The calculation of such quotients may be performed by dividing the exponentiated value from each requester by the summation of each exponentiated value (e.g., the summation of all exponentiated values).

In operation 954, regardless whether the corresponding share for each requester has been calculated by the share allocator 240 in operation 950 or by the exponent manager 230 in operation 640, the share allocator 240 allocates each calculated share (e.g., percentage) to its corresponding requester. This may be performed in a manner described above with respect to FIG. 3, and FIG. 4, or FIG. 5.

In some example embodiments, time-based sharing and allocation of the shareable item 300 is implemented (e.g., as discussed above with respect to FIG. 3). According to these scenarios, the share allocator 240 may perform operation 960 as part of operation 954. In operation 960, the share allocator 240 allocates the portions 320 of the time span 310 that the shareable item 300 is available, and this allocation may be based on the calculated share (e.g., percentage) for each corresponding requester (e.g., each of the requesters 122, 132, 142, and 152).

In certain example embodiments, quantity-based sharing and allocation of the shareable item 300 is implemented (e.g., as discussed above with respect to FIG. 4). According to these scenarios, the share allocator 240 may perform operation 970 as part of operation 954. In operation 970, the share allocator 240 allocates the portions 420 of the total quantity 410 accountable benefits available from the shareable item 300, and this allocation may be based on the calculated share (e.g., percentage) for each corresponding requester (e.g., each of the requesters 122, 132, 142, and 152).

As shown in FIG. 9, operation 980 may be performed after operation 650. In operation 980, the share allocator 240 provides exclusive use of the shareable item 300 to one of the requesters (e.g., requester 122) based on the share (e.g., portion or percentage) that was allocated to that requester in operation 650 (e.g., during performance of operation 954). Operation 980 may be performed repeatedly (e.g. cyclically, routinely, or regularly) to provide, deliver, cause to be delivered, assign, or otherwise allocate the shareable item 300 to different requesters (e.g., requesters 122, 132, 142, and 152) at different times (e.g., different occasions). For example, where the shareable item 300 is an allocable region of a GUI, the repeated performance of operation 980 may have the effect of causing the allocable region to be linked to requester machines (e.g., requester machines 120, 130, 140, and 150) of these different requesters at different times, such as different occasions for causing the user device (e.g., user device 16)) to display the GUI to a user (e.g., user 162).

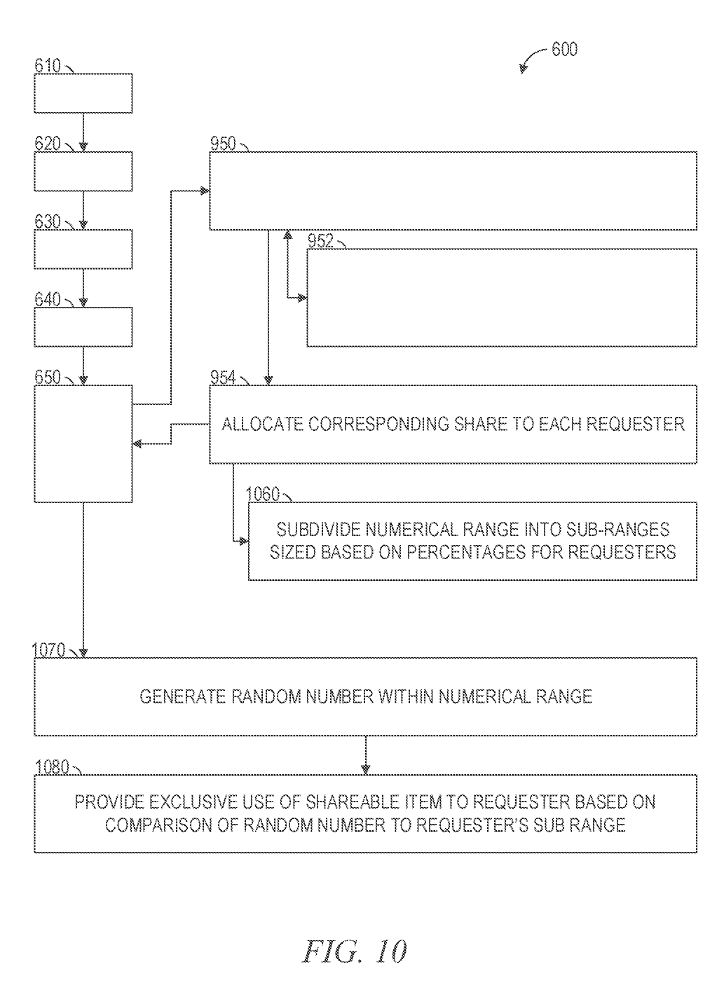

As shown in FIG. 10, in addition to any one or more of the operations previously described with respect to FIGS. 1-8, the method 600 may include one or more of operations 950, 952, 954, 1060, 1070, and 1080. Operations 950, 952, and 954 may be performed by the share allocator 240 as described above with respect to FIG. 9. In various example embodiments, the weighted random sharing and allocation of the shareable item 300 is implemented (e.g., as discussed above with respect to FIG. 5). According to these scenarios, the share allocator 240 may perform operation 1060 as part of operation 954. In operation 1060, the share allocator 240 subdivides the numerical range 510 into the sub-ranges 520, which may be sized based on the corresponding shares (e.g., percentages) calculated for each requester in operation 950.

As additionally shown in FIG. 10, operation 1070 may be performed after operation 1060 is performed as part of operation 650. In operation 1070, the share allocator 240 generates a random number that falls within the numerical range 510 and falls within one of the sub-ranges 520 (e.g., into the sub-range 521 that corresponds to the requester 122).

In operation 1080, the share allocator 240 identifies the requester (e.g., requester 122) to which the shareable item 300 is to be provided, based on which sub-range (e.g., sub-range 521) among the sub-ranges 520 encompasses the random number generated in operation 1060. For example, the share allocator 240 may perform a comparison of the random number to one or more of the sub-ranges 520 (e.g., at least the sub-range 521 in which the random number falls). Accordingly, in operation 1080, the share allocator 240 provides exclusive use of the shareable item 300 to the requester (e.g., requester 122) whose corresponding sub-range (e.g., sub-range 521) includes the random number generated in operation 1070. Operation 1080 may be performed repeatedly to provide, deliver, cause to be delivered, assign, or otherwise allocate the shareable item 300 to different requesters (e.g., requesters 122, 132, 142, and 152) at different times (e.g., different occasions). For example, where the shareable item 300 is an allocable region of a GUI, the repeated performance of operation 1080 may have the effect of causing the allocable region to be linked to requester machines (e.g., requester machines 120, 130, 140, and 150) of these different requesters at different times, such as different occasions for causing the user device (e.g., user device 160) to display the GUI to a user (e.g., user 162).

According to various example embodiments, one or more of the methodologies described herein may facilitate automated decision-making regarding how to apportion and allocate the shareable item 300 (e.g., via dynamic exponentiation). Moreover, one or more of the methodologies described herein may facilitate such automated apportionment and allocation of the shareable item 300 in response to changing values accorded by requesters (e.g., requesters 122, 132, 142, and 152) for the shareable item 300, as well as automated guidance of such apportionment and allocation of the shareable item directly or indirectly toward a goal, such as a predetermined ultimate share of the shareable item 300 or a calculated target intermediate share of the shareable item 300. Hence, one or more of the methodologies described herein may facilitate improvements to the experiences of the requesters in requesting and obtaining the shareable item 300, as well as improvements in the experiences of users (e.g., users 162 and 172) in interacting with the shareable item 300, as allocated to different requesters at different times, compared to capabilities of pre-existing systems and methods.

When these effects are considered in aggregate, one or more of the methodologies described herein may obviate a need for certain efforts or resources that otherwise would be involved in automated decision-making regarding how to apportion and allocate the shareable item 300 (e.g., via dynamic exponentiation). Efforts expended by a user (e.g., user 162), requester (e.g., requester 122), or an administrator of the item sharing machine 110 in interacting with, requesting, obtaining, allocating, or managing the shareable item 300 may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically. FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be communicatively coupled (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof) a main memory 1104, and a static memory 1106, which are configured to communicate with each other via a bus 1108. The processor 1102 contains solid-state digital microcircuits (e.g., electronic, optical, or both) that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein. In some example embodiments, the processor 1102 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1100 with at least the processor 1102, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a pointer input device 1114 (e.g., a mouse, a touchpad, a touchscreen, a trackball, a joystick, a stylus, a motion sensor, an eye tracking device, a data glove, or other pointing instrument), a data storage 1116, an audio generation device 1118 (e.g., a sound card, an amplifier, a speaker, a headphone jack, or any suitable combination thereof), and a network interface device 1120.

The data storage 1116 (e.g., a data storage device) includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the static memory 1106, within the processor 1102 (e.g., within the processor's cache memory), or any suitable combination thereof, before or during execution thereof by the machine 1100. Accordingly, the main memory 1104, the static memory 1106, and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device (e.g., a smart phone, a tablet computer, or a wearable device), and may have one or more additional input components 1130 (e.g., sensors or gauges). Examples of such input components 1130 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g. a gas sensor) Input data gathered by any one or more of these input components may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g. a centralized or distributed database, or associated caches and servers) able to store instructions. The term “machine-readable medium” shall also be taken to include any medium, or combination of multiple media, that is capable of carrying (e.g., storing or communicating) the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 1124 for execution by the machine 1100 can be communicated via a carrier medium (e.g. a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 1124).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the meth ds discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors of a machine, a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining, by one or more processors of the machine, a target extremum percentage of the shareable item;
determining, by one or more processors of the machine, a common exponent based on the target extremum percentage and based on each value in the plurality of values;
exponentiating, by one or more processors of the machine, each value among the plurality of values to the determined common exponent; and
allocating, by one or more processors of the machine, a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

2. The method of claim 1, wherein:
the extremum value is a maximum value relative to the plurality of values;
the target extremum percentage of the shareable item is a target maximum percentage of the shareable item; and
the allocating of the plurality of percentages of the shareable item includes allocating the target maximum percentage of the shareable item to a requester among the plurality of requesters, the requester having submitted the maximum value.

3. The method of claim 1, wherein:
the extremum value is a minimum value relative to the plurality of values;
the target extremum percentage of the shareable item is a target minimum percentage of the shareable item; and
the allocating of the plurality of proportions of the shareable item includes allocating the target minimum percentage of the shareable item to a requester among the plurality of requesters, the requester having submitted the minimum value.

4. The method of claim 1, wherein:
the determining of the target extremum percentage includes accessing a predetermined ultimate percentage; and
the determining of the common exponent determines the common exponent that produces the predetermined ultimate percentage when each value in the plurality of values is exponentiated to the common exponent and the exponentiated extremum value is divided by the summation of each exponentiated value.

5. The method of claim 4, wherein:
the accessing of the predetermined ultimate percentage includes accessing a data structure that indicates the predetermined ultimate percentage is a monopoly definition percentage.

6. The method of claim 1, wherein:
in the allocating of the plurality of percentages of the shareable item, each requester among the plurality of requesters is allocated a corresponding percentage calculated by dividing the corresponding exponentiated value among the plurality of values by the summation of each exponentiated value among the plurality of values.

7. The method of claim 1, wherein:
the shareable item is available for sharing during a time span; and the method further comprises:
allocating portions of the time span to the plurality of requesters based on the plurality of percentages allocated to the plurality of requesters; and
providing exclusive use of the shareable item to each requester among the plurality of requesters based on a corresponding allocated portion of the time span.

8. The method of claim 1, wherein:
the shareable item is available for sharing during a time span in which the shareable item provides a total quantity of discrete non-shareable items; and the method further comprises:
allocating portions of the total quantity of discrete non-shareable items to the plurality of requesters based on the plurality of percentages allocated to the plurality of requesters; and
providing exclusive use of the shareable item to each requester among the plurality of requesters based on a corresponding allocated portion of the total quantity of discrete non-shareable items.

9. The method of claim 1, further comprising:
subdividing a numerical range into sub-ranges that each correspond to a different requester among the plurality of requesters and whose sizes are determined based on the plurality of percentages; and
providing exclusive use of the shareable item to a requester among the plurality of requesters based on a comparison of a randomly generated number to a sub-range that corresponds to the requester.

10. The method of claim 1, wherein:
the determining of the common exponent includes calculating the common exponent based on the determined target extremum percentage of the shareable item.

11. A non-transitory machine-readable storage medium comprising instructions that, when executed by one or more processors of a machine, cause the machine to perform operations comprising:
accessing a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining a target extremum percentage of the shareable item;
determining a common exponent based on the target extremum percentage and based on each value in the plurality of values;
exponentiating each value among the plurality of values to the determined common exponent; and
allocating a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

12. The non-transitory machine-readable storage medium of claim 11, wherein:
a first requester among the plurality of requesters submitted the extremum value among the plurality of values;
the determining of the target extremum percentage includes calculating a target intermediate percentage partway between a predetermined ultimate percentage and a current percentage that is presently allocated to the first requester that submitted the extremum value; and
the determining of the common exponent determines the common exponent that produces the calculated target intermediate percentage when each value in the plurality of values is exponentiated to the common exponent and the exponentiated extremum value is divided by the summation of each exponentiated value.

13. A system comprising:
one or more processors; and
a memory storing instructions that, when executed by at least one processor among the one or more processors, cause the system to perform operations comprising:
accessing a plurality of values collectively submitted by a plurality of requesters for a shareable item, each value in the plurality of values being assigned to the shareable item by a different corresponding requester among the plurality of requesters, the plurality of values including an extremum value relative to the plurality of values;
determining a target extremum percentage of the shareable item;
determining a common exponent based on the target extremum percentage and based on each value in the plurality of values;
exponentiating each value among the plurality of values to the determined common exponent; and
allocating a plurality of percentages of the shareable item to the plurality of requesters based on the plurality of exponentiated values, each requester in the plurality of requesters being allocated a corresponding percentage of the shareable item based on a corresponding exponentiated value among the exponentiated plurality of values.

14. The system of claim 13, wherein:
a first requester among the plurality of requesters submitted the extremum value among the plurality of values;
the determining of the target extremum percentage includes calculating a target intermediate percentage partway between a predetermined ultimate percentage and a current percentage that is presently allocated to the first requester that submitted the extremum value; and
the determining of the common exponent determines the common exponent that produces the calculated target intermediate percentage when each value in the plurality of values is exponentiated to the common exponent and the exponentiated extremum value is divided by the summation of each exponentiated value.
